(19) United States
(12) Patent Application Publication
(10) Pub. No.: US 2026/0289073 A1
(43) Pub. Date: Sep. 24, 2026

(54) SENTENCE GENERATION MODEL GENERATION DEVICE, SENTENCE GENERATION MODEL GENERATION METHOD, AND SENTENCE GENERATION DEVICE

(71) Applicant: NTT DOCOMO, INC., Tokyo (JP)

(72) Inventor: Masayuki KAWARADA, Tokyo (JP)

(73) Assignee: NTT DOCOMO, INC., Tokyo (JP)

(21) Appl. No.: 19/473,625

(22) PCT Filed: Jul. 8, 2024
(86) PCT No.: PCT/JP2024/024620

§ 371 Date: Oct. 8, 2025

(30) Foreign Application Priority Data
Sep. 11, 2023 (JP) 2023-146866

(51) Int. Cl. G06F 40/166; G06N 3/0475; G06N 3/08

(52) U.S. Cl. CPC G06F 40/166; G06N 3/0475; G06N 3/08

(57) ABSTRACT

The sentence generation model generation device (10) includes a learning unit (11) configured to, in response to input of an input sentence, identify, from the input sentence, a claim and a premise that supports the claim from the same standpoint as the claim or from a different standpoint than the claim, perform at least one of labeling the claim and the premise and labeling a relation between the claim and the premise, and conduct machine learning using the input sentence as an explanatory variable and the text of the labeled portion as an objective variable, to perform training of a sentence generation model for generating and outputting a text sentence related to a structure of the input sentence and generate the sentence generation model.

### TECHNICAL FIELD

The present disclosure relates to a sentence generation model generation device, a sentence generation model generation method, and a sentence generation device.

### BACKGROUND ART

As an example of a task for structuring documents, a technique called argument mining is known, which identifies an author's claims, premises, and the like from a document and clarifies their logical structure. For instance, Non-Patent Literature 1 below proposes a multitask learning approach that simultaneously performs the following three tasks: (1) extraction of arguments (portions that contain claims and premises) from a document, (2) labeling of components (claims and premises), and (3) labeling of relations (relations between claims and premises).

### CITATION LIST

### Non Patent Literature

[Non-Patent Literature 1] Gaku Morio et al., “End-to-end Argument Mining with Cross-corpora Multi-task Learning,” published in May 2022.

### SUMMARY OF INVENTION

### Technical Problem

In the technique described in Non-Patent Literature 1, since the above three tasks must be executed simultaneously, complex parameter adjustments are required to achieve a certain level of accuracy or higher in document structuring tasks, making it difficult to simplify processing and achieve further performance improvements.

In view of the above circumstances, the present disclosure aims to eliminate the need for complex parameter adjustments conventionally required to achieve a certain level of accuracy or higher in document structuring tasks, thereby simplifying processing and improving performance.

### Solution to Problem

A sentence generation model generation device according to the present disclosure includes a learning unit configured to, in response to input of an input sentence, identify, from the input sentence, a claim and a premise that supports the claim from the same standpoint as the claim or from a different standpoint than the claim, perform at least one of labeling the claim and the premise and labeling a relation between the claim and the premise, and conduct machine learning using the input sentence as an explanatory variable and the text of the labeled portion as an objective variable, to perform training of a sentence generation model for generating and outputting a text sentence related to a structure of the input sentence, and generate the sentence generation model. Here, the “claim” corresponds, for example, to a claim in an argument mining task or a claim in a structuring task targeting posts on social networking services (SNS), and the “premise” corresponds, for example, to a premise in an argument mining task or evidence in a structuring task targeting posts on social networking services (SNS).

### Advantageous Effects of Invention

According to the present disclosure, a sentence generation model with both input and output being text can be obtained through the above machine learning. By using the trained sentence generation model in document structuring tasks, it is possible to eliminate the need for complex parameter adjustments conventionally required to achieve a certain level of accuracy or higher, thereby simplifying processing and improving performance. Additionally, the model can be applied not only to argument mining tasks but also to various tasks involving document structuring.

### BRIEF DESCRIPTION OF DRAWINGS

FIG. 1 is a configuration diagram of a sentence generation device including a sentence generation model generation device according to an embodiment.

FIG. 2 is a flowchart illustrating processing in a learning phase of a sentence generation model.

FIG. 3(a) is a diagram for explaining the identification of arguments in an argument mining task, FIG. 3(b) is a diagram for explaining the labeling of components in an argument mining task, and

FIG. 3(c) is a diagram for explaining the labeling of relations in an argument mining task.

FIG. 4 is a diagram illustrating an example of a text sentence representing a tree structure.

FIG. 5 is a flowchart illustrating processing in an inference phase.

FIG. 6 is a diagram illustrating a document including a major claim, claims, and premises.

FIG. 7 is a diagram illustrating the document structure of the document shown in FIG. 6.

FIG. 8(a) is a diagram illustrating an example of an input sentence, and FIG. 8(b) is a diagram illustrating the document structure of the input sentence in FIG. 8(a).

FIG. 9 is a diagram for explaining the effects of the embodiment.

FIG. 10(a) is a diagram illustrating an example of an input sentence, FIG. 10(b) is a diagram illustrating an output example when outputting portions that do not contain components, and FIG. 10(c) is a diagram illustrating an output example when not outputting portions that do not contain components.

FIG. 11 is a diagram for explaining the effects when not outputting portions that do not contain components.

FIG. 12(a) is a diagram illustrating an example of an input sentence, and FIG. 12(b) is a diagram illustrating an output example for Pattern A (subtasks (1) to (3)).

FIG. 13(a) is a diagram illustrating an output example for Pattern B (subtasks (1) and (2) only), and FIG. 13(b) is a diagram illustrating an output example for Pattern C (subtasks (1) and (3) only).

FIG. 14(a) is a diagram illustrating a first modification of the system configuration, FIG. 14(b) is a diagram illustrating a second modification of the system configuration, and FIG. 14(c) is a diagram illustrating a third modification of the system configuration.

FIG. 15 is a diagram illustrating an example of the hardware configuration of the sentence generation model generation device.

### DESCRIPTION OF EMBODIMENTS

Hereinafter, an embodiment of the present disclosure will be described with reference to the drawings. The technology of the present disclosure can be applied to various document structuring tasks, including: (1) structuring essays defined in three levels of major claims, claims (normal claims) and premises; (2) structuring essays defined in two levels of claims and premises; and (3) structuring posts on social networking services (SNS) defined in two levels of claims and evidence (corresponding to premises). As a basic example, an application of the present disclosure to an argument mining task for structuring essays defined in two levels of claim and premise will be described first.

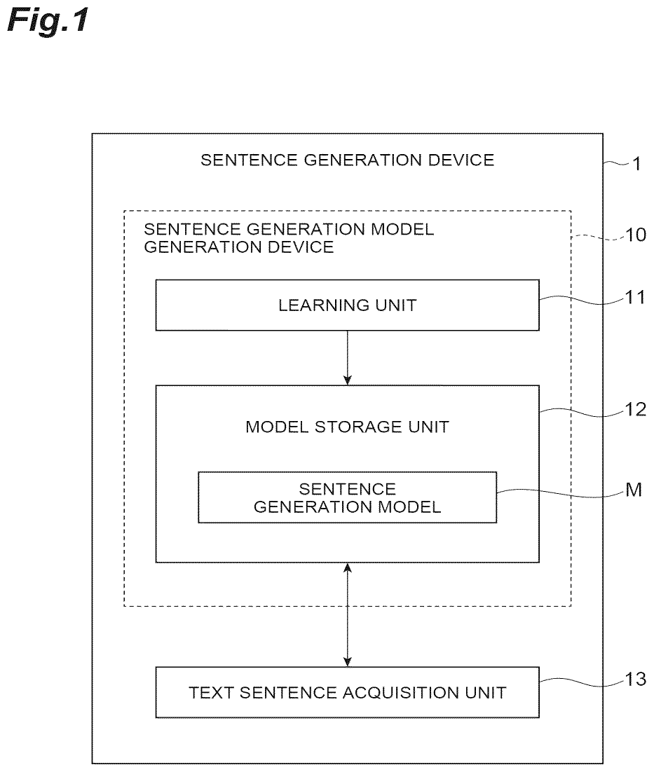

FIG. 1 illustrates an example of a system configuration. As shown in FIG. 1, a sentence generation device 1 includes a sentence generation model generation device 10 that generates a sentence generation model M, which is a learning model for generating and outputting a text sentence related to a structure of an input sentence. The sentence generation model M, as described later, has both input and output being a text sentence, and is configured by using a general pre-trained encoder-decoder model, thereby eliminating the need for conventional parameter adjustments.

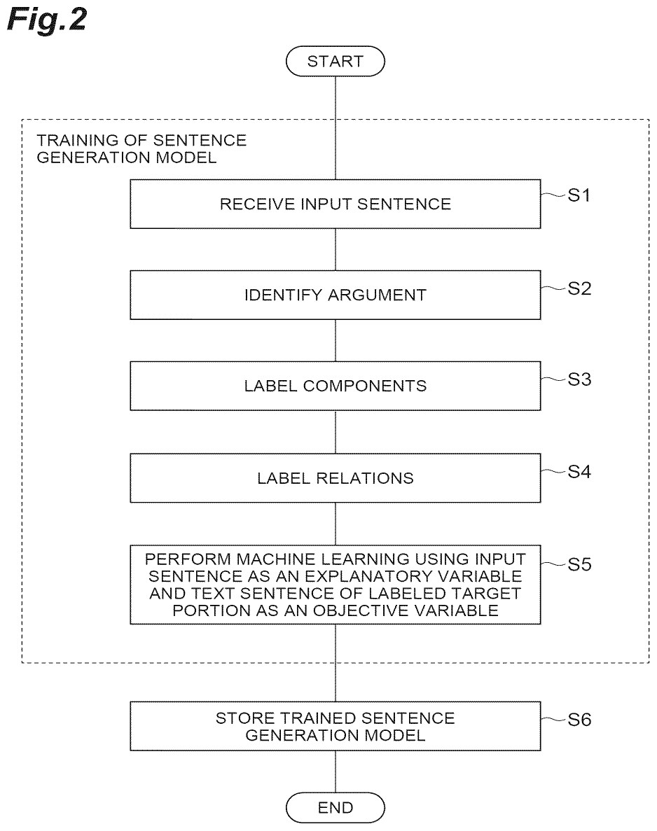

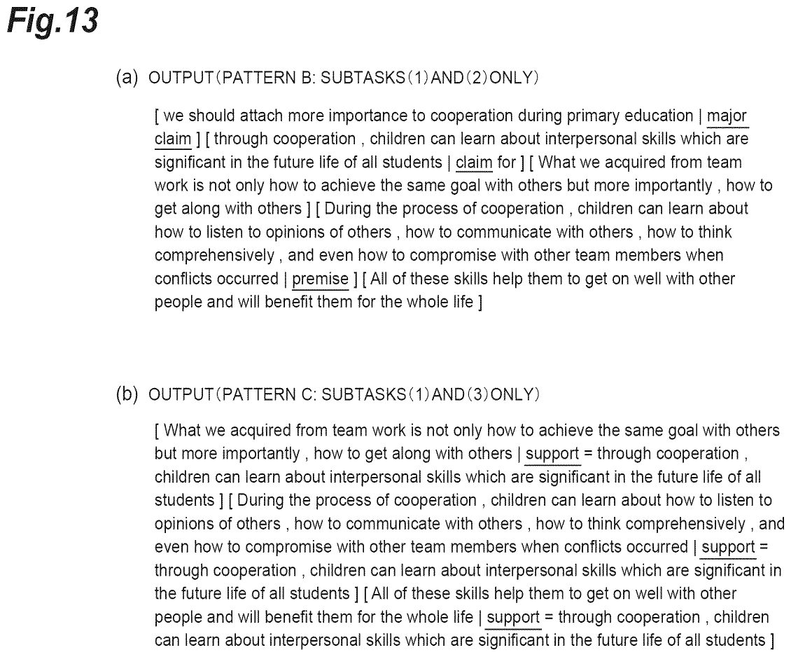

The sentence generation model generation device 10 includes, as functional blocks for realizing the functions of the present disclosure, a learning unit 11 that performs training of the sentence generation model M to generate the sentence generation model M, and a model storage unit 12 that stores the generated sentence generation model M. The sentence generation device 1 includes the sentence generation model generation device 10 described above and a text sentence acquisition unit 13 that acquires, as output from the sentence generation model M, a text sentence related to the structure of a target input sentence by inputting the target input sentence into the sentence generation model M. The details of the functions of each unit will be described below in conjunction with the explanation of the processes based on FIG. 2 to FIG. 5. The system configuration is not limited to the configuration shown in FIG. 1, and other system configurations may also be adopted. Other system configurations will be described later with reference to FIGS. 13(a) to 13(c).

### Processing Executed by Sentence Generation Model Generation Device 10: Learning-Phase Processing

Next, the processing executed by the sentence generation model generation device 10 (learning-phase processing) will be described with reference to the flowchart in FIG. 2.

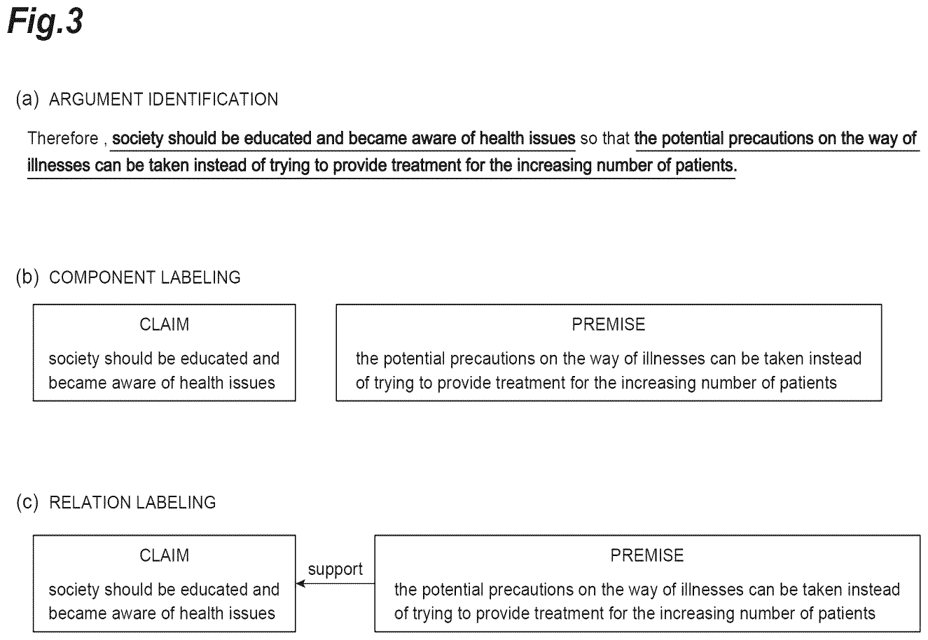

First, the learning unit 11 of the sentence generation model generation device 10 receives an input sentence from an external source (step S1 in FIG. 2) and identifies arguments (portions that contain claims and premises) in the argument mining task (step S2). Here, a “claim” corresponds to a claim, and a “premise” corresponds to a premise that supports the claim from the same standpoint as the claim or from a different standpoint than the claim. For example, the learning unit 11 identifies, as arguments, the underlined portions in the input sentence shown in FIG. 3(a), namely, “society should be educated and became aware of health issues” and “the potential precautions on the way of illnesses can be taken instead of trying to provide treatment for the increasing number of patients.”

Next, the learning unit 11 performs labeling of components (claims and premises) (step S3). For example, as shown in FIG. 3(b), the learning unit 11 labels “society should be educated and became aware of health issues,” identified in step S2, as a claim, and labels “the potential precautions on the way of illnesses can be taken instead of trying to provide treatment for the increasing number of patients” as a premise.

Next, the learning unit 11 performs labeling of the relation between the claim and the premise (step S4). Here, since the premise supports the claim from the same standpoint as the claim, the learning unit 11 labels “support” as the relation between the claim and the premise as shown in FIG. 3(c). Conversely, if the premise supports the claim from an opposing standpoint from the claim, the learning unit 11 labels “attack” as the relation between the claim and the premise.

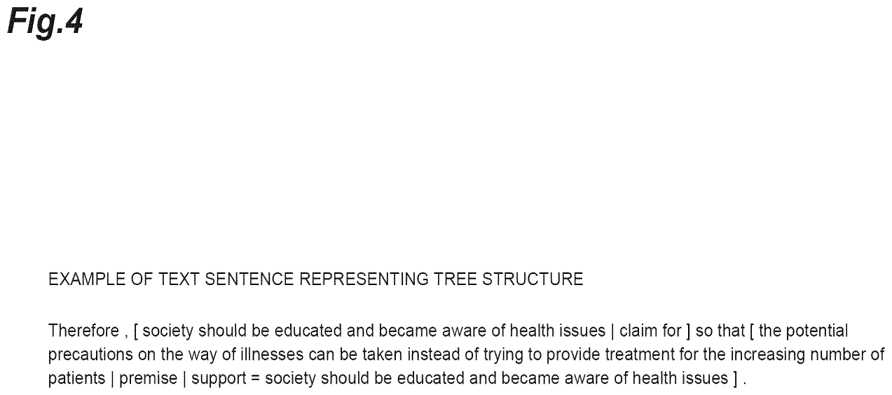

Then, the learning unit 11 conducts machine learning using the input sentence as an explanatory variable and the text sentence of the labeled portions as an objective variable (step S5). The text sentence used as the objective variable is, for example, as shown in FIG. 4, represented for the input sentence (FIG. 3(a)) as follows: the portion labeled as a claim is expressed as [society should be educated and became aware of health issues|claim for], and the portion labeled as a premise is expressed as [the potential precautions on the way of illnesses can be taken instead of trying to provide treatment for the increasing number of patients|premise|support =society should be educated and became aware of health issues].

Here, the latter part of the portion labeled as a premise, “support =society should be educated and became aware of health issues,” indicates the relation that the premise supports (supports from the same standpoint as) the claim.

The processing of steps SI to S5 described above corresponds to the training of the sentence generation model. Furthermore, the model storage unit 12 stores the trained sentence generation model M (step S6). In this manner, the trained sentence generation model M is generated and stored.

### Processing Executed by Sentence Generation Device 1: Inference-Phase Processing

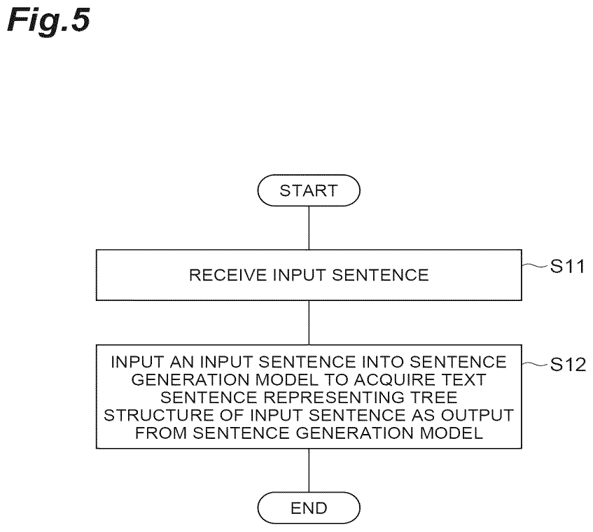

Next, the processing executed by the sentence generation device 1 (inference-phase processing) will be described with reference to the flowchart in FIG. 5.

The text sentence acquisition unit 13 of the sentence generation device 1 receives an input sentence from an external source (step S11 in FIG. 5) and, by inputting the input sentence into the sentence generation model M, acquires, as output from the sentence generation model M, a text sentence representing the tree structure of the input sentence (step S12). The “text sentence representing the tree structure” acquired here is, as in the example of FIG. 5 described above, represented with claims and premises indicated in square brackets, and the latter part of the premise indicates the relation between the claim and the premise (in the example of FIG. 5, “support,” meaning that the premise supports the claim from the same standpoint as the claim).

In the embodiment described above, through the processing in FIG. 2, a sentence generation model with both input and output being text can be generated. By using the obtained trained sentence generation model in document structuring tasks, it is possible to eliminate the need for complex parameter adjustments conventionally required to achieve a certain level of accuracy or higher, thereby simplifying processing and improving performance. Additionally, the model can be applied not only to argument mining tasks but also to various tasks involving document structuring.

### Another Aspect

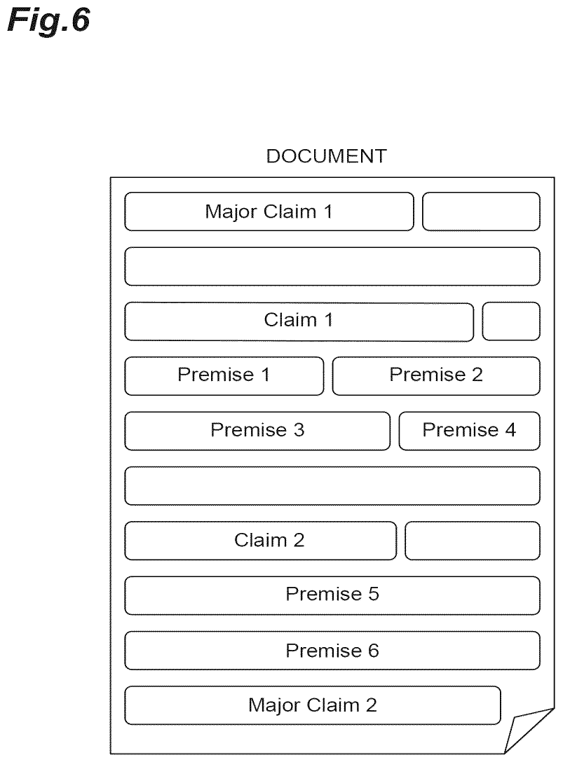

Here, the structuring of essays defined in three levels of major claims, claims (normal claims), and premises, as mentioned at the beginning of the embodiment, will be described with reference to FIG. 6 to FIG. 8.

Similar to the relation between “claims” and “premises” described above, the relation between “major claims” and “claims” can also be identified. Specifically, in a single document, it is possible to identify one or more “claims” that support a major claim from the same standpoint as the “major claim” or from an opposing standpoint than the “major claim”. When supporting from the same standpoint as the “major claim”, the relation is defined as “for,” and when supporting from an opposing standpoint from the “major claim”, the relation is defined as “against.”

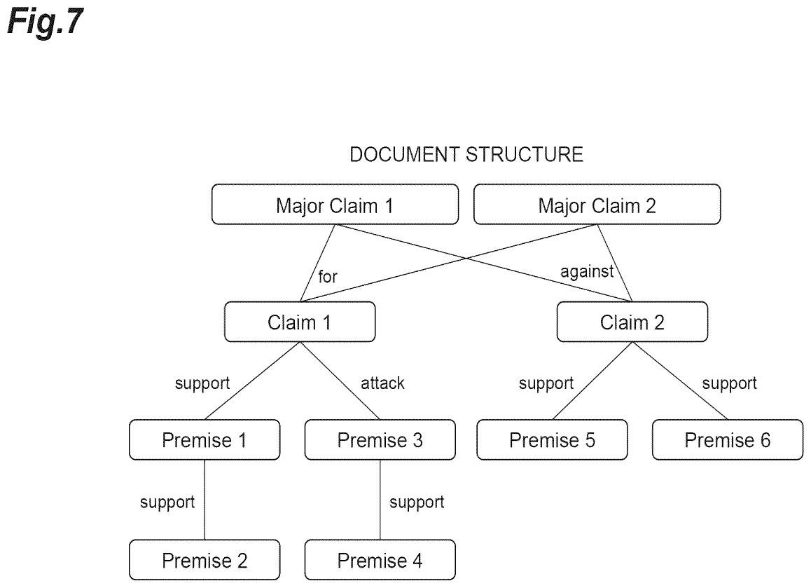

FIG. 6 illustrates an example of a document in which arguments (portions that contain major claims, claims, and premises) in an argument mining task have been identified. FIG. 7 illustrates an example of a document structure in which two major claims, two claims, and six premises identified in FIG. 6 are labeled, and their relations are also labeled.

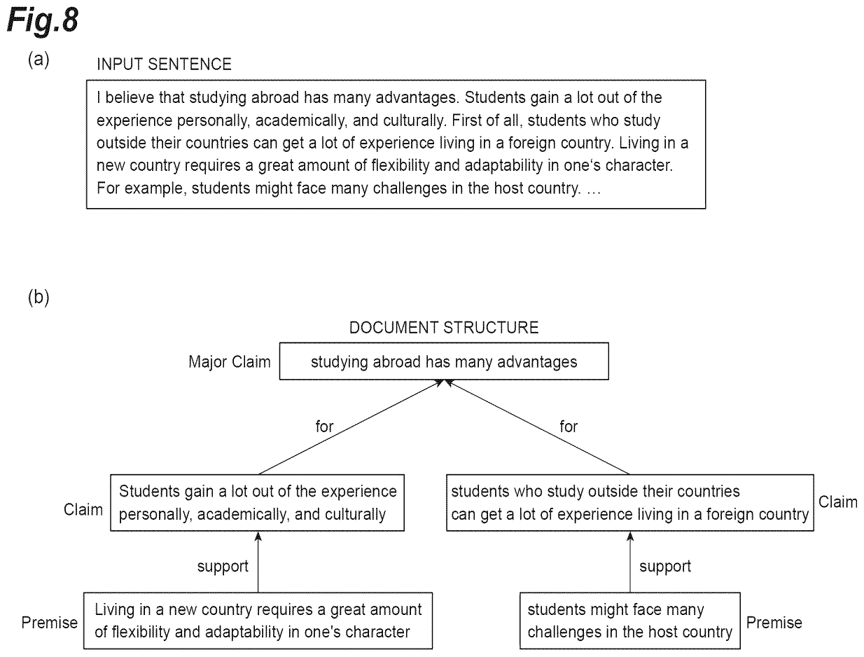

As a specific example, when the input sentence shown in FIG. 8(a) is input, as illustrated in FIG. 8(b), one major claim, two claims, and two premises are labeled. Additionally, the relations between the major claim and the claims (both “for” in this case) and the relations between the claims and the premises (both “support” in this case) are labeled.

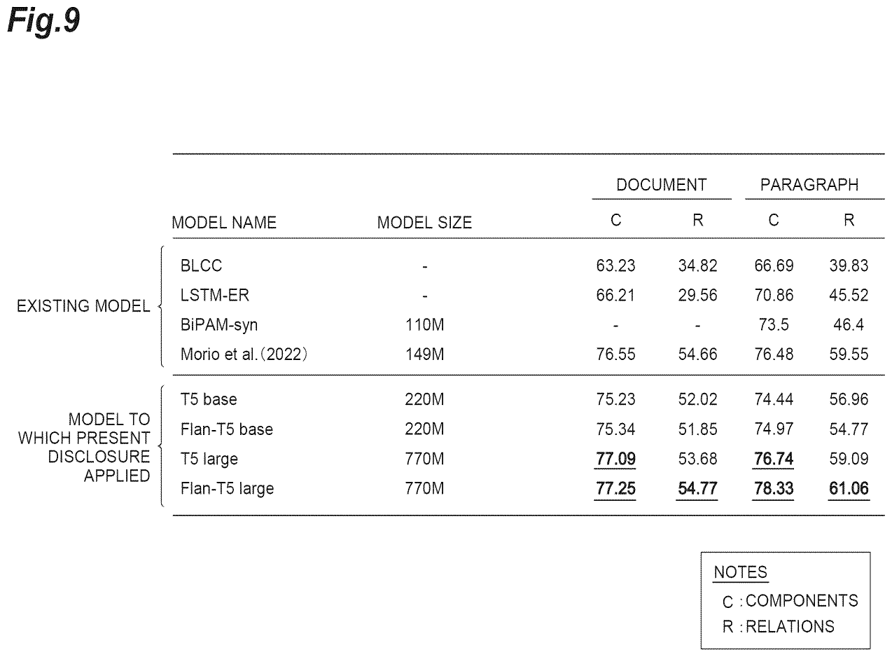

FIG. 9 is a table showing the “matching rate (unit: %)” as a performance for an existing model and a model to which the present disclosure is applied, where a higher matching rate indicates better performance. In the table, “C” represents the matching rate for labeled components, and “R” represents the matching rate for labeled relations, with the matching rates shown as evaluation values for “document units” and “paragraph units”. Among the models applying the present disclosure in FIG. 9, “T5 base” is a natural language processing model (model size: 220M) published by Google (registered trademark), and “Flan-T5 base” is an improved version of T5 base for zero-shot learning. Similarly, “T5 large” is a natural language processing model (model size: 770M) published by Google, and “Flan-T5 large” is an improved version of T5 large for zero-shot learning. The evaluation values (matching rates) underlined in the table in FIG. 9 indicate that the model applying the present disclosure has superior performance to any existing model, demonstrating that inference performance is improved by the present disclosure.

### Innovations in Output Format

The following describes innovations related to the output format in the present disclosure. Specifically, the learning unit 11 performs training using, as the objective variable in machine learning, text that includes only the identified components (claims and premises). In other words, the training is conducted so that the text sentence output from the sentence generation model M consists of text that does not contain portions other that components (claims and premises) (that is, text containing only components). In practice, it is sufficient to output only the identified components, and there is little need to output the entire document, including extraneous portions (portions other than the identified components). On the other hand, outputting extraneous portions increases the number of decoding operations during processing in a pre-trained encoder-decoder model, which increases decoding processing time and may ultimately lead to performance degradation. Therefore, the above innovation eliminates such concerns and improves performance.

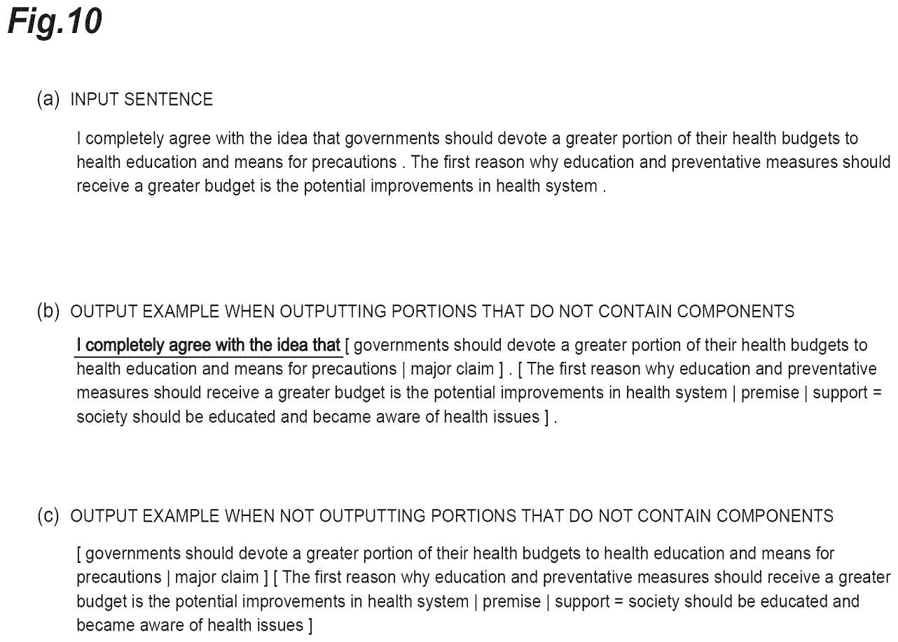

For example, in the input sentence shown in FIG. 10(a), when outputting “portions that do not contain components (claims and premises),” as shown in FIG. 10(b), even the portion “I completely agree with the idea that,” which is a “portion not containing components,” is output. In contrast, by setting the objective variable in machine learning to text containing only the identified components, the learning unit 11 generates a sentence generation model M that, as shown in FIG. 10(c), does not output the portion “I completely agree with the idea that,” which is a “portion not containing components.”

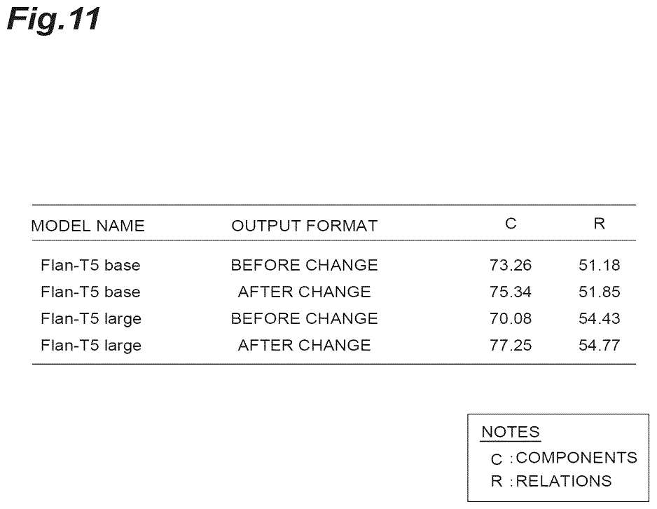

FIG. 11 shows the performance (matching rate (unit: %)) for “Flan-T5 base” and “Flan-T5 large” before and after changing the output format as described above. In the table, “C” represents the matching rate for labeled components, and “R” represents the matching rate for labeled relations.

From FIG. 11, it can be seen that for both the “Flan-T5 base” and “Flan-T5 large” models, the matching rates for labeled components and labeled relations are improved after the change in output format compared with before (that is, performance is improved).

### Variation of Processing in FIG. 2

In the embodiment described above, an example was described in which the present disclosure is applied to an argument mining task that performs all three subtasks: (1) argument identification, (2) component labeling, and (3) relation labeling. However, in practice, there are cases where it is not necessary to perform all of the subtasks (1) to (3). For example, when it is desired to label only the claims and premises in an input sentence to determine their total number or to identify the locations of claims and premises in the input sentence, only subtasks (1) and (2) need to be performed. Additionally, when it is desired to determine only whether some structure exists in the input sentence, regardless of labels such as claims or premises, only subtasks (1) and (3) need to be performed.

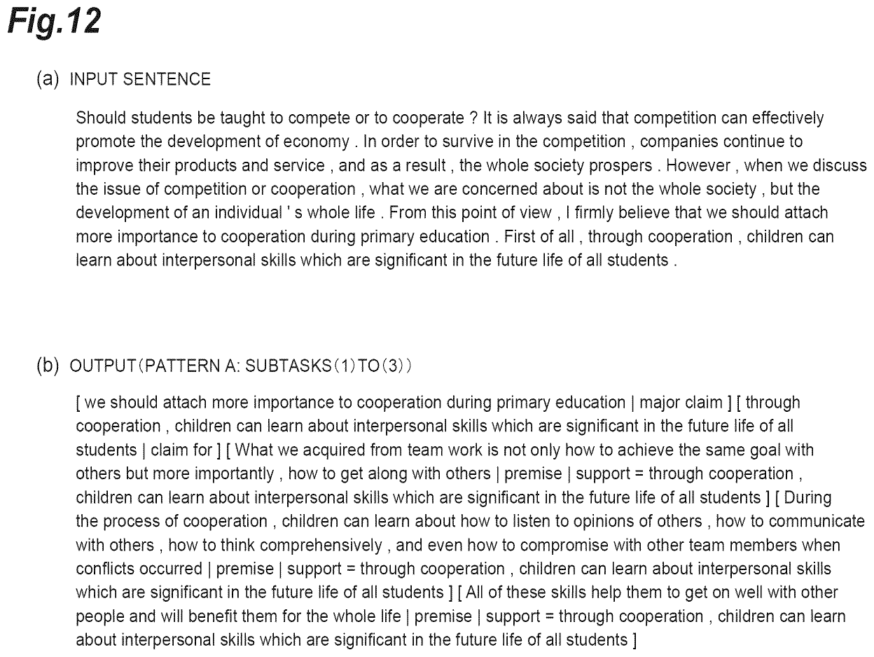

As a specific example, when the input sentence shown in FIG. 12(a) is input, the output example for Pattern A (performing all subtasks (1) to (3)) is the text sentence shown in FIG. 12(b). Thus, a text sentence representing a tree structure including labeled components and labeled relations is output.

On the other hand, the output example for Pattern B (performing only subtasks (1) and (2)) is the text sentence shown in FIG. 13(a). Although it does not include labeled relations, since the labeled components (major claims, claims, and premises) are indicated as underlined portions, the total number of components and their locations in the input sentence can be identified. For convenience of explanation, the labeled components in FIG. 13(a) are underlined, but in the actual output text sentence, no underlining is applied. The same applies to FIG. 13(b).

Additionally, the output example for Pattern C (performing only subtasks (1) and (3)) is the text sentence shown in FIG. 13(b). Although it does not include labeled components, since the labeled relations (in this case, three “support” relations) are indicated as underlined portions, the presence of some structure in the input sentence can be identified.

### Variations of System Configuration

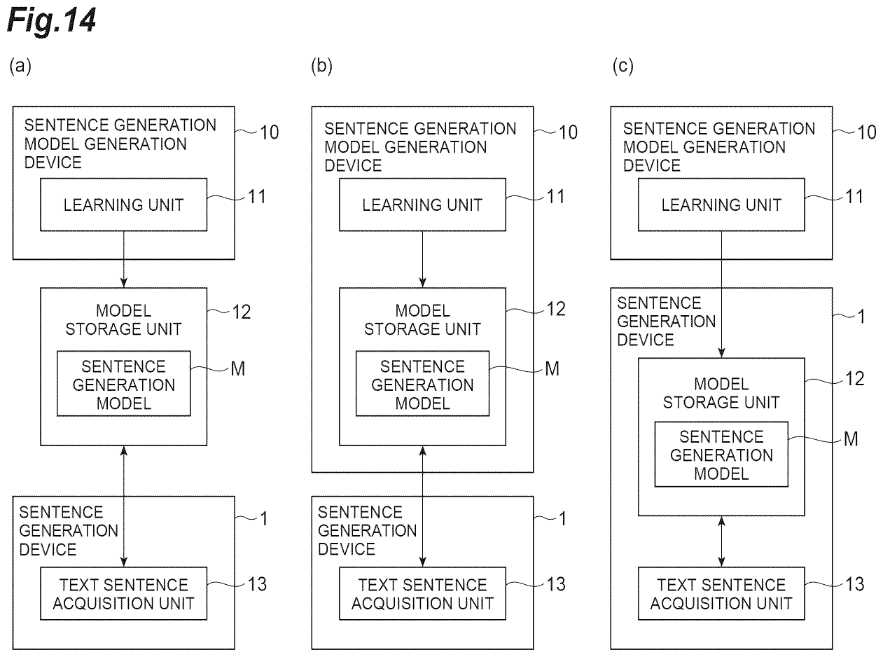

As mentioned earlier, the system configuration is not limited to the configuration shown in FIG. 1, and other system configurations exemplified in FIG. 14(a) to FIG. 14(c) may be adopted. For example, as shown in FIG. 14(a), the sentence generation model generation device 10, the model storage unit 12, and the sentence generation device 1 may be configured as mutually independent devices. Alternatively, as shown in FIG. 14(b), the sentence generation model generation device 10 may be configured as a device independent from the sentence generation device 1, with the model storage unit 12 included within the sentence generation model generation device 10. Furthermore, as shown in FIG. 14(c), the sentence generation model generation device 10 may be configured as a device independent from the sentence generation device 1, with the model storage unit 12 included within the sentence generation device 1. Even with these various system configurations, the same effects as those of the embodiment described above can be achieved.

This disclosure includes the following features [1] to [5].

[1] A sentence generation model generation device comprising:
a learning unit configured to,
in response to input of an input sentence, identify, from the input sentence, a claim and a premise that supports the claim from the same standpoint as the claim or from a different standpoint than the claim,
perform at least one of labeling the claim and the premise and labeling a relation between the claim and the premise, and
conduct machine learning using the input sentence as an explanatory variable and the text of the labeled portion as an objective variable, to perform training of a sentence generation model for generating and outputting a text sentence related to a structure of the input sentence, and generate the sentence generation model.

[2] The sentence generation model generation device according to [1], wherein the learning unit is further configured to:
identify, as the claim, a major claim that is a main claim and a normal claim that supports the major claim from the same standpoint as the major claim or from a different standpoint than the major claim, and
perform at least one of labeling the major claim and the normal claim and labeling a relation between the major claim and the normal claim.

[3] The sentence generation model generation device according to [1] or [2], wherein the learning unit sets the objective variable in the machine learning to text that includes only the identified claim and premise.

[4] A sentence generation model generation method executed by a sentence generation model generation device, comprising:
a step of performing training of a sentence generation model for generating and outputting a text sentence related to a structure of an input sentence, to generate the sentence generation model, the step including:
   a sub step of identifying, from the input sentence, a claim and premise that supports the claim from the same standpoint as the claim or from a different standpoint than the claim,
   a sub step of performing at least one of labeling the claim and the premise and labeling a relation between the claim and the premise, and
   a sub step of conducting machine learning using the input sentence as an explanatory variable and the text of the labeled portion as an objective variable.

[5] A sentence generation device comprising:
a text sentence acquisition unit configured to acquire, as output from a sentence generation model generated by the sentence generation model generation device according to any one of [1] to [3], a text sentence related to the structure of a target input sentence, by inputting the target input sentence into the sentence generation model.

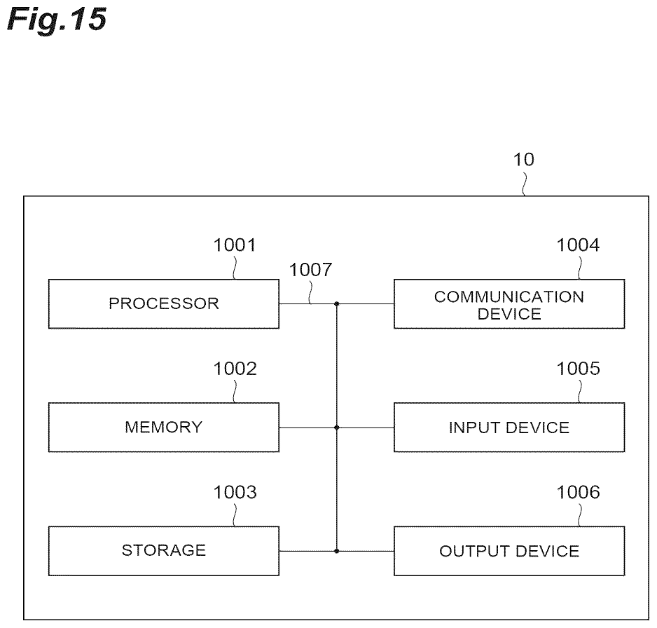

### Explanation of Terms, Description of Hardware Configuration (FIG. 15), etc.)

In the block diagrams with reference to which the embodiment has been described, blocks of functional units are illustrated. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. A functional block may be realized by one device or a plurality of devices described above and software in combination.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (component) that causes transmission to function is called a transmitting unit or transmitter. In either case, as described above, realization methods are not particularly limited.

For example, the sentence generation model generation device according to an embodiment of the present disclosure may function as a computer that performs processing of the present disclosure. FIG. 15 is a diagram illustrating an example of a hardware configuration of the sentence generation model generation device 10 according to the embodiment of the present disclosure. The above-described sentence generation model generation device 10 may be physically configured as a computer device including a processor 1001, a memory 1002, a storage 1003, a communication device 1004, an input device 1005, an output device 1006, a bus 1007, and the like. The hardware configuration of the sentence generation device 1 may be similar to that of the sentence generation model generation device 10.

In addition, in the following description, a term “device” may be rephrased as a circuit, a device, a unit, or the like. The hardware configuration of the sentence generation model generation device 10 may be configured to include one or more of respective devices shown in the figure, or may be configured not to include some of the devices.

The processor 1001 performs an arithmetic operation by reading predetermined software (a program) onto hardware such as the processor 1001 or the memory 1002, and thus each function of the sentence generation model generation device 10 is realized by controlling communication in the communication device 1004 or controlling at least one of reading-out and writing of data in the memory 1002 and the storage 1003.

The processor 1001, for example, controls the entire computer by operating an operating system. The processor 1001 may be configured as a central processing unit (CPU) including an interface with peripherals, a controller, an arithmetic operation unit, and a register.

The processor 1001 reads a program (a program code), a software module, data, or the like from the storage 1003 and/or the communication device 1004 to the memory 1002 and performs various processes in accordance therewith. As the program, a program that causes a computer to perform at least some of the operations described above in the embodiment is used. The various processes described above are described as being performed by a single processor 1001, but they may be simultaneously or sequentially performed by two or more processors 1001. The processor 1001 may be mounted as one or more chips. The program may be transmitted from a network via an electrical communication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store an executable program (program code), a software module, or the like that can be executed to perform a wireless communication method according to an embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage medium described above, for example, may be a database including at least one of the memory 1002 and a storage 1003, a server, or any other appropriate medium.

The communication device 1004 is hardware (a transmitting and receiving device) that performs communication between computers via a wired and/or wireless network and is also referred to as, for example, a network device, a network controller, a network card, or a communication module. The communication device 1004, for example, in order to realize at least one of frequency division duplex (FDD) and time division duplex (TDD), may be configured to include a high frequency switch, a duplexer, a filter, a frequency synthesizer, and the like.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

The devices such as the processor 1001 and the memory 1002 are connected to each other via the bus 1007 for transmission of information. The bus 1007 may be configured using a single bus, or may be configured using different buses between devices.

In addition, the sentence generation model generation device 10 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be mounted using at least one of these types of hardware.

Notification of information is not limited to an aspect/embodiment described in the present disclosure and may be performed using a difference method. For example, the notification of information may be performed using physical layer signaling (for example, downlink control information (DCI), uplink control information (UCI)), upper layer signaling (for example, radio resource control (RRC) signaling, medium access control (MAC) signaling, a master information block (MIB), a system information block (SIB)), any other signal, or a combination thereof. In addition, the RRC signaling may be referred to as a RRC message and, for example, may be an RRC connection setup message, an RRC connection reconfiguration message, or the like.

Each aspect or embodiment described in the present disclosure may be applied to at least one of the following systems: Long Term Evolution (LTE), LTE-Advanced (LTE-A), SUPER 3G, IMT-Advanced, Fourth Generation Mobile Communication System (4G), Fifth Generation Mobile Communication System (5G), Sixth Generation Mobile Communication System (6G), xth Generation Mobile Communication System (xG, where x is, for example, an integer or a decimal), Future Radio Access (FRA), New Radio (NR), New Radio Access (NX), Future Generation Radio Access (FX), Wideband Code Division Multiple Access (W-CDMA, registered trademark), Global System for Mobile Communications (GSM, registered trademark), CDMA 2000, Ultra Mobile Broadband (UMB), IEEE 802.11 (Wi-Fi, registered trademark), IEEE 802.16 (WiMAX, registered trademark), IEEE 802.20, Ultra-WideBand (UWB), Bluetooth (registered trademark), systems that use other suitable systems, and at least one next-generation system that has been extended, modified, created, or defined based on any of the above systems. In addition, a plurality of systems may be combined (for example, a combination of at least one of LTE and LTE-A and 5G or the like) for an application.

The order of processes, the sequences, the flowcharts, and the like of the aspects/embodiments described above in the present disclosure may be changed unless conflictions arise. For example, in the methods described in the present disclosure, various steps are described as elements of an exemplary order, but the methods are not limited to the described order.

Information or the like which is input or output may be stored in a specific place (for example, a memory) or may be managed using a management table. Information or the like which is input or output may be overwritten, updated, or added. The output information and the like may be deleted. The input information and the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in this disclosure may be used alone, may be used in combination, or may be switched during implementation thereof. In addition, a notification of predetermined information (for example, a notification of being X) is not limited to be performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the spirit and scope of the present disclosure as defined by the claims. Thus, the description presented in the present disclosure is for the purpose of exemplary description and does not have any limited meaning for the present disclosure.

It is apparent that software, regardless whether it is called software, firmware, middleware, microcode, hardware description language, or any other name, should be widely interpreted to mean a command, a command set, a code, a code segment, a program code, a program, a subprogram, a software module, an application, a software application, a software package, a routine, a subroutine, an object, an executable file, an execution thread, a procedure, a function, and the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

Information, a signal, and the like described in the present disclosure may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, a term described in the present disclosure and a term that is necessary for understanding the present disclosure may be substituted with terms having the same meaning or a meaning similar thereto. For example, at least one of a channel and a symbol may be a signal (signaling). For example, a signal may be a message. In addition, a component carrier (CC) may be referred to as a carrier frequency, a cell, a frequency carrier, or the like.

The terms “system” and “network” used in the present disclosure are used interchangeably.

In addition, information, parameters, and the like described in the present disclosure may be expressed using absolute values, may be expressed using values relative to a predetermined value, or may be expressed using other corresponding information. For example, radio resources may be directed using indices.

A name used for each parameter described above is not limited in any aspect. In addition, numerical equations using such parameters may be different from those that are explicitly disclosed in the present disclosure. Various channels (for example, a PUCCH, a PDCCH, and the like) and information elements can be identified using all the preferred names, and various names assigned to such various channels and information elements are not limited in any aspect.

Terms such as “determining” used in the present disclosure may include various operations of various types. The “determining”, for example, may include a case in which judging, calculating, computing, processing, deriving, investigating, looking up, search, and inquiry (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining.” Furthermore, “determining” may include a case in which resolving, selecting, choosing, establishing, comparing, or the like is regarded as “determining.” In other words, “determining” includes a case in which a certain operation is regarded as “determining.” In addition, “determining” may be rephrased with “assuming”, “expecting”, “considering”, and the like.

The expression “based on” used in the present disclosure does not mean “based on only” unless otherwise described. In other words, description of “on the basis of” means both “only on the basis of” and “at least on the basis of.”

Any referring to elements, for which names of “first”, “second”, and the like are used, used in the present disclosure does not generally limit the amount or the sequence of such elements. The terms can be conveniently used to distinguish two or more elements in the present disclosure. Accordingly, referring to the first and second elements does not mean that only the two elements are employed therein or the first element precedes the second element in a certain form.

When the terms “include” and “including” and modifications thereof are used in the present disclosure, the terms are intended to have a comprehensive meaning similar to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, a term “A and B are different” may mean that “A and B are different from each other.” The expression may mean that “A and B are different from C.” Expressions such as “separated” and “coupled” may be construed in the same way as “different.”

### REFERENCE SIGNS LIST

1: sentence generation device, 10: sentence generation model generation device, 11: learning unit, 12: model storage unit, 13: text sentence acquisition unit, m: sentence generation model, 1001: processor, 1002: memory, 1003: storage, 1004: communication device, 1005: input device, 1006: output device, 1007: bus

1. A sentence generation model generation device comprising:
a learning unit configured to,
in response to input of an input sentence, identify, from the input sentence, a claim and a premise that supports the claim from the same standpoint as the claim or from a different standpoint than the claim,
perform at least one of labeling the claim and the premise and labeling a relation between the claim and the premise, and
conduct machine learning using the input sentence as an explanatory variable and the text of the labeled portion as an objective variable, to perform training of a sentence generation model for generating and outputting a text sentence related to a structure of the input sentence, and generate the sentence generation model.

2. The sentence generation model generation device according to claim 1, wherein the learning unit is further configured to:
identify, as the claim, a major claim that is a main claim and a normal claim that supports the major claim from the same standpoint as the major claim or from a different standpoint than the major claim, and
perform at least one of labeling the major claim and the normal claim and labeling a relation between the major claim and the normal claim.

3. The sentence generation model generation device according to claim 1, wherein the learning unit sets the objective variable in the machine learning to text that includes only the identified claim and premise.

4. A sentence generation model generation method executed by a sentence generation model generation device, comprising:
a step of performing training of a sentence generation model for generating and outputting a text sentence related to a structure of an input sentence, to generate the sentence generation model, the step including:
a sub step of identifying, from the input sentence, a claim and premise that supports the claim from the same standpoint as the claim or from a different standpoint than the claim,
a sub step of performing at least one of labeling the claim and the premise and labeling a relation between the claim and the premise, and
a sub step of conducting machine learning using the input sentence as an explanatory variable and the text of the labeled portion as an objective variable.

5. A sentence generation device comprising:
a text sentence acquisition unit configured to acquire, as output from a sentence generation model generated by the sentence generation model generation device according to claim 1, a text sentence related to the structure of a target input sentence, by inputting the target input sentence into the sentence generation model.
